(19) United States
(12) Patent Application Publication
(10) Pub. No.: US 2008/0179024 A1
(43) Pub. Date: Jul. 31, 2008

(54) Blind Arrangement for a Motor Vehicle

(75) Inventors: Mathis Fichter, Muenchen (DE); Horst-Martin Schulz, Weil (DE); Karin Langguth, Gauting (DE); Michael Koelbl, Neuried (DE); Sebastian Glasl, Muenchen (DE)

Correspondence Address: ROBERTS MLOTKOWSKI SAFRAN & COLE, P.C., P. O. BOX 10064, MCLEAN, VA, 22102-8064, US

(73) Assignee: WEBASTO AG, Stockdorf (DE)

(21) Appl. No.: 11/576,092

(22) PCT Filed: Sep. 23, 2005
(86) PCT No.: PCT/DE05/01690

§ 371 Date: Nov. 16, 2007

(30) Foreign Application Priority Data
Sep. 27, 2004 (DE) 10 2004 046 783.8

(51) Int. Cl. B60J 1/20

(52) U.S. Cl. 160/370.22

(57) ABSTRACT

A shade arrangement for a motor vehicle with a shade which has a shade material (10) one end of which is attached to a take-up tube (12) which is supported on a take-up shaft (14), and the other end of which is connected to a pull (16). Furthermore, with a motor I provided within the take-up tube for turning the take-up shaft. The shade arrangement also has at least one flexible drive element (20, 26) which is not directly connected to the take-up shaft and is connected to the pull such that rotation of the take-up shaft in the unwinding direction of a shade material leads to a force being applied by the drive element on the pull to move it. The motor is a tube motor which is extends within the take-up tube.

### BACKGROUND OF THE INVENTION

1. Field of the Invention

This invention relates to a shade arrangement for a motor vehicle having a take-up tube which is supported on a take-up shaft, a pull, a shade having a shade material material, a first end of which is attached to the take-up tube and an opposite second end of which is connected to the pull, a motor for turning the take-up shaft, and at least one flexible driving element which is nonpositively connected to the take-up shaft and the pull for moving the shade material.

1. Description of Related Art

Generic shade arrangements for motor vehicles are known from various patents For example, German Patent DE 198 34 777 C2 describes a sunshade for a transparent roof pane of a motor vehicle in which a shade material material is attached on one end to a take-up tube which is rotationally supported on a take-up roll. The other end of the shade material is connected to a pull which is driven by a compressively stiff driving cable which is unwound from a cable drum on the take-up shaft for unwinding the length of shade. The take-up shaft itself is moved by an external, motorized driving unit.

German Patent Application DE 101 55 167 A1 discloses a shade arrangement in which a take-up shaft is likewise driven by a driving motor, the connection between the motor and take-up shaft in this case consisting of a slip clutch or shift clutch. In this case, the motor with the clutch is attached as a separate unit laterally to the shade arrangement. The shade is drawn via a sheathed cable mechanism, the cable being supported on a conical cable drum on the take-up shaft laterally of the shade.

German Patent DE 101 24 100 C1 and corresponding U.S. Pat. No. 6,682,133 B2 likewise disclose a shade device for a transparent roof element in which a shade material material is unrolled from the take-up shaft by means of a sheathed cable device, here in any case the pull on the shade material being provided with two deflection rolls which deflect a traction cable which is anchored on the body on one end and on the other end is wound onto a cable drum which is coupled to the electric motor.

In vehicle construction, shade means are also known in which a tube motor is installed in the take-up shaft as the driving unit. In these arrangements, the shade is drawn either by means of spring-loaded articulated arms and is taken up again by the tube motor (see in this respect, for example, German Patent DE 196 41 554 C1 and corresponding U.S. Pat. No. 6,109,330, and German Patent Application DE 35 39 513 A1) or a shade material with a transparent region and a shadowing region is wound back and forth between two take-up shafts on either side of the window, either the two shafts being driven via one or two motors or alternatively one take-up shaft being pretensioned by means of a rotary spring (see in this respect German Utility Model DE 299 16 738 U1 and German Patent Application DE 197 22 722 A1).

The indicated shade arrangements for motor vehicles have the disadvantage that, when external motors are used both for the motor itself and also for the gearing and possibly a clutch, a comparatively large installation space in the motor vehicle is necessary. This disadvantage also arises in the known shade arrangements with tubular motors when a shade material is wound back and forth between two take-up shafts. Furthermore, the systems in which a take-up shaft is driven with a tube motor and the shade is drawn, however, via spring-loaded articulated arms, have the disadvantage that they clear the view to the articulated arms especially when the shade is only partially drawn.

### SUMMARY OF THE INVENTION

Thus, a primary object of this invention is to devise a shade system for motor vehicles of the initially mentioned type in which both an economical design with as few parts as possible and also an aesthetically pleasing result can be achieved.

This object is achieved by a shade system in which at least one flexible driving element is nonpositively connected to the take-up shaft and the pull and rotation of the take-up shaft by the driving element in an unwinding direction of the shade material material produces a force on the pull that moves the shade material, the driving element being a tube motor which is located within the take-up tube.

In accordance with the invention, a flexible driving element is nonpositively connected to the take-up shaft, on the one hand, and a pull, on the other, so that rotation of the take-up shaft in the unwinding direction of the shade material on the take-up shaft leads to the action of a force by the flexible driving element on the pull and moves it. In the approach in accordance with the invention, it is advantageous that, by integration of a motor as a tube motor within the take-up tube, on the one hand, and unwinding of the shade material by means of a flexible driving element, on the other hand, a shade arrangement is achieved which can be produced economically and which also can be installed with a small installation space in a motor vehicle. The cost is reduced especially by the number of individual parts which is distinctly reduced compared to the known systems.

In preferred embodiments of the invention, the driving element is made compressively stiff, and in especially preferred versions, can be made in the form of a guided toothed belt which is engaged by a gearwheel which is supported on the take-up shaft. When using a flexible driving element, such as a guided toothed belt, much less installation space is necessary than for the known designs, in which the shade material is rewound between two take-up rolls or must be extended from the articulation arm. A guided toothed belt, as compared to a closed toothed belt which is moved between two gearwheels, likewise has the advantage of small installation depth. The guided toothed belt is driven by a gearwheel which engages the toothed belt and itself is, in turn, supported on a take-up shaft and is turned together with the take-up shaft. Preferably, the diameter of the gearwheel is at least as great as the diameter of the take-up tube including the completely taken-up shade material material so that, when the shade material material is unwound, tension in the shade is built up and maintained. The shade material material can, itself, can be produced from a corresponding elastic material in preferred embodiments or in a dynamic connection between the tube motor and the pull, i.e., between the tube motor and take-up shaft or between the take-up shaft and the shade material or a spring element can be additionally installed between the shade material and pull to accommodate part of the tension which has built up.

In addition to these embodiments of the invention, with a driving element which is made compressively stiff, the shade material can however also be drawn by means of a cable pull. One preferred embodiment of the invention has a cable which can be rolled on a cable drum which is assigned to it and which is supported on the take-up shaft laterally next to the length of shade, and which cable is connected via at least one body-mounted deflection roller to the pull such that, when the take-up shaft is turned in the unwinding direction of the length of shade, the pull is drawn by the cable. The cable drum can be made conical here in order to keep both the unwinding speed of the cable and also that of the shade material the same. The unwinding speed is reduced for the shade material in unwinding from the take-up roller with increasing drawing length of the shade by the decreasing take-up diameter of the length of shade. The cable is therefore wound onto the conical cable drum such that the take-up diameter is also maximum here at the start of drawing of the shade and is reduced with increasing drawing length of the shade.

In other preferred embodiments of the invention with a cable as the driving element, the cable is branched in a Y-shape and the two ends are connected to the pull via body-mounted deflection rolls. The deflection rolls are located preferably in the vicinity of the two corners of the completely drawn, preferably rectangular length of shade. The Y-shaped splitting of the cable therefore has the advantage that the pull can be drawn on both sides of the length of shade, by which skewing of the shade arrangement is prevented. Furthermore, especially flat installation depths can be achieved by drawing the pull by means of a cable and deflection rolls.

In another preferred embodiment of the invention with a cable-shaped drive element, the pull on its two ends has a deflection roller on each of the side edges of the shade material, and the cable (preferably, likewise rolled up from the conical cable drum on the take-up shaft), first, via a first, body-mounted deflection roller which, in the vicinity of the corner of the completely drawn shade is located on the same side of the shade material as the cable drum, is further guided to be able to move by 180° relative to the pull via its two deflection rolls and is anchored on the end at a point on the body. Preferably, the entire deflection of the cable is 360° and the anchoring point in the vicinity of the corner of the completely drawn shade is located on the side of the shade material which is opposite the cable drum. In this preferred embodiment of the invention, a very flat construction of the shade arrangement is also achieved.

In all embodiments of the invention, sliders can also be attached to the pull which are guided with especially low friction in body-mounted guides.

The invention is explained in detail below with reference to the accompanying drawings.

### BRIEF DESCRIPTION OF THE DRAWINGS

FIG. 1 is a perspective view of shade arrangement in accordance with the invention for a motor vehicle with a toothed belt as the flexible driving element;

FIG. 2 is a perspective view of a shade arrangement with a cable as the driving element which is branched in a Y-shape; and

FIG. 3 is a perspective view of a shade arrangement with a cable as the drive element and in which the pull is guided by means of three deflection rolls and is anchored on a body-mounted point.

### DETAILED DESCRIPTION OF THE INVENTION

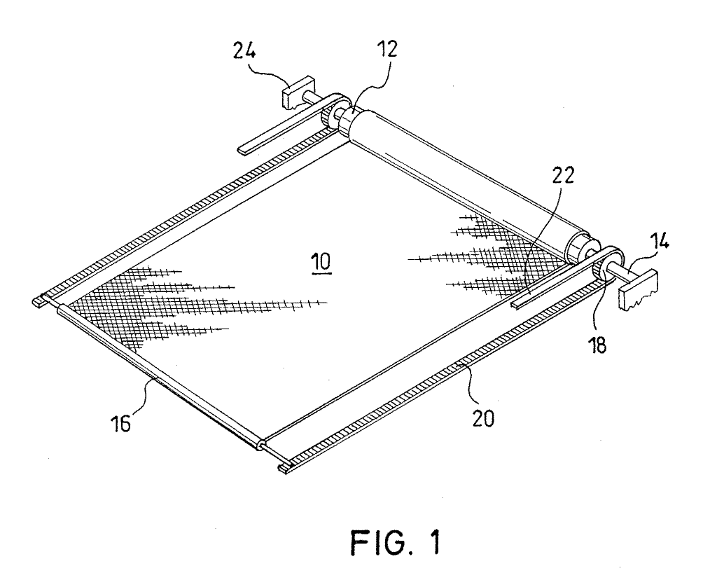

FIG. 1 shows a shade arrangement for a motor vehicle with a shade material material 10 which is attached on one end to a take-up tube 12 on which it can be taken up, the take-up tube being rotatably mounted on a take-up shaft 14. The other end of the shade material 10 is connected to the pull 16 which can be moved by a guided toothed belt 20. In this case, the flexible toothed belt 20 is guided in a guide arrangement (not shown) such that it can be used as a compressively stiff, flexible driving element. The toothed belt 20 is driven by a gearwheel 18 which has teeth which engage the toothed belt and which is, likewise, supported on the take-up shaft 14. The toothed belt 20, in the embodiment shown here, is not a closed (endless) belt, but is an open, linear toothed belt, in which an end 22 of the toothed belt is deflected around the gearwheel 18 and is likewise guided in a guide (not shown). The use of an open toothed belt 22 has the advantage that only one gearwheel 18 is necessary to deflect the toothed belt. Conversely, an endless toothed belt necessitates the installation of two gearwheels; this increases the required installation space. Furthermore, for an open toothed belt 20, cheaper yard goods can be used in production; this further reduces production costs.

The gear wheel 18 and the take-up shaft 14 are driven in accordance with the invention by a tube motor which is located within the take-up tube and which therefore is not visible. As soon as the tube motor of the take-up shaft 14 is moved in a direction for drawing (extending) the shade material 10 (in the figures rotation clockwise), the take-up shaft 14 and the gearwheel 18 are turned, by which the shade material 10 is unrolled, on the one hand and on the other hand, the pull 16 attached on the end of the shade material is pushed to the left in the figure by the guided toothed belt 20. The gear wheel 18 has a diameter which corresponds to the diameter of the take-up tube 12 including the completely taken-up shade material 10, so that, the shade is advanced, the difference between the pushing speed of the toothed belt 20 and the unrolling speed of the shade material 10 leads to an increasing return tension in the shade material 10. When using a correspondingly elastic shade material 10, this tension leads to the shade material remaining tightly tensioned in each position. Alternatively or additionally, in the dynamic connection between the tube motor and the pull 16, spring elements can also be installed to partially accommodate the tensile stress.

For installation in the vehicle body in the region of a window or a cover panel for a closable roof opening or for installation in a roof module for a vehicle, the take-up shaft 14 is supported in body-mounted or module-mounted holding devices 24 and the toothed belt 20 is guided compressively stiffly in the corresponding guides, such as, for example, guide rails. In order to avoid skewing of the pull 16 when the shade material 10 is being drawn out or taken up, the toothed belt 20 and the gear wheel 18, as shown, can be duplicated and made in mirror image on both sides of the shade material 10.

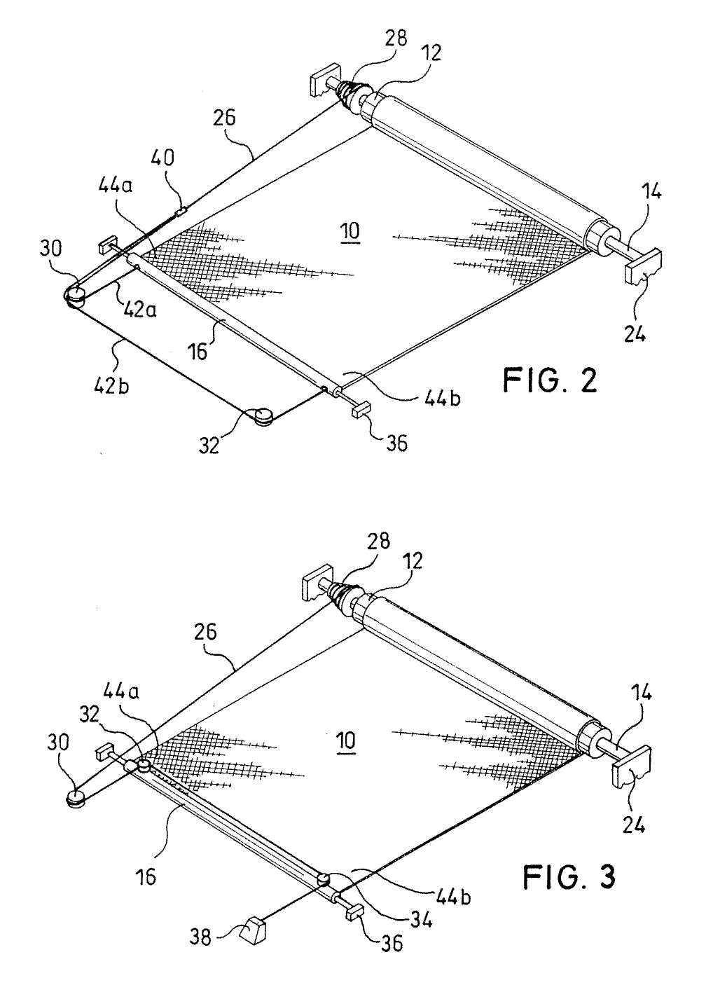

FIG. 2 shows a perspective view of another shade arrangement in accordance with the invention. Here too, shade material 10 is being unrolled from the take-up tube 12 which is supported on the take-up shaft 14, the shade material being attached on one drawing end to the pull 16. The pull 16 is supported by means of sliders 36 in guide rails (not shown). Likewise, a tube motor within the take-up tube drives the shade arrangement. As in all other embodiments of the invention, the tube motor can be, for example, an electric motor.

In contrast to the shade arrangement from FIG. 1, the shade material 10 shown here is drawn off from the take-up tube 12, not by a compressively stiff driving element, such as, for example, a guided toothed belt, but a cable 26 which is taken up on a conical cable drum 28 that has a winding direction which is the reverse of the shade material 10, and this cable is used to wind the shade material 10. For this purpose, the cable 26 has a Y-shape which branches at junction 40 into two cable ends 42a, 42b. The two cable ends 42a, 42b are deflected by means of a common deflection roller 30 such that one cable end 42a is directly deflected 180° and is attached to the end of the pull 16 which is located in the vicinity of the cable 26. The other cable end 42b is deflected only 90° by the deflection roller 30 to a second deflection roller 32 which again deflects this cable by 90°. Thus, the cable end 42b altogether undergoes 180° deflection, with the cable end 42b then being attached to the opposite end of the pull 16 from the cable end 42a.

In this shade arrangement in accordance with the invention, the shade material 10 is unrolled by the take-up shaft 14, and thus, the take-up tube 12 is turned clockwise by the tubular motor. By turning the conical cable drum 28 likewise clockwise, in the take-up direction of the cable 26 on the cable drum which is reversed compared to the take-up direction of the shade material 10 on the take-up tube 12, the cable is taken up onto the cable drum, and thus, the pull 16 is drawn down to the left from the two cable ends 42a, 42b in the direction of the figure. The cable 26 is thus taken up onto the conical cable drum 28 such that the speed of the cable 26, and thus of the pull 16, corresponds roughly over the entire drawing path of the shade material 10 to the unrolling speed of the length of shade. Thus, the shade material can be kept under a fixed, constant tension over the entire drawing length of the shade arrangement.

FIG. 3 shows a shade arrangement in which, likewise, a cable 26 can be taken up and unrolled on a conical cable drum 28. Here too, the cable drum is supported on the take-up shaft 14 with a take-up tube 12 which has a tube motor attached within it to drive the shade arrangement. In contrast to FIG. 2, the cable 26 is not branched here. First cable 26 is deflected 180° by means of a first deflection roller 30, similarly to the deflection rolls of FIG. 2, the deflection roller 30 being attached to the vehicle body preferably in the vicinity of the corner of the shade material when it is completely drawn, at the side on which the cable drum 28 is also supported on the take-up shaft 14. The cable 26 continues to run from roller 30 to a second deflection roller 32 where it is deflected by 90°. The second deflection roller 32 is attached on the pull 16 and from which the cable guidance continues parallel to the pull 16 until the cable 26 is then again deflected by 90° on the other end of the pull by means of another, third deflection roller 34 such that it again runs parallel to the original unrolling direction from the cable drum 28 and thus parallel to the shade material 10. After this last deflection, the cable end is fixed on the body at a fastening point 38, the position of the fastening point 38 being in the vicinity of the corner of the shade material 10 when it is completely drawn and at the side of the shade material opposite the cable drum 28.

In this shade arrangement, rotation of the take-up tube 12, on the one hand, leads to delivery of the shade material 10 from the take-up tube, and on the other hand, to taking up of the cable 26 onto the cable drum 28. Thus, parallel to unrolling the shade material 10, it is drawn by the pull 16 by cable 26 at the take-up speed of the cable that is equal to the unrolling speed of the shade material due to the conical shape of the cable drum 28 for the full extent that the shade material 10 drawn out.

What is claimed is:

1-14. (canceled)

15. Shade arrangement for a motor vehicle, comprising:
a take-up tube which is supported on a take-up shaft;
a pull;
a shade having a length of shade material, a first end of which is attached to the take-up tube and an opposite second end of which is connected to the pull;
a motor for turning the take-up shaft; and
at least one flexible driving element which is nonpositively connected to the take-up shaft and the pull;
wherein rotation of the take-up shaft by the driving element in an unwinding direction of the length of shade material produces a force on the pull that moves the shade material, the motor being a tube motor which is located within the take-up tube.

16. Shade arrangement as claimed in claim 15, wherein the driving element is compressively stiff.

17. Shade arrangement as claimed in claim 16, wherein the at least one flexible driving element is a guided toothed belt which is engaged by a gearwheel that is supported on the take-up shaft.

18. Shade arrangement as claimed in claim 17, wherein the gearwheel has a diameter that is at least as great as a diameter of the take-up tube including the thickness of the shade material when it is fully rollered up on the take-up tube.

19. Shade arrangement as claimed in claim 15, further comprising a spring element in dynamic connection between the tube motor and the pull.

20. Shade arrangement as claimed in claim 15, wherein the shade material is an elastic material.

21. Shade arrangement as claimed in claim 15, wherein the at least one flexible driving element comprises at least one cable, and wherein a cable drum for taking up the cable is provided on the take-up shaft laterally next to a side edge of the shade material, wherein the at least one cable is connected to the pull via at least one body-mounted deflection roller such that the pull is drawn when the take-up shaft turns in an unrolling direction of the shade material.

22. Shade arrangement as claimed in claim 21, wherein the cable drum is conical.

23. Shade arrangement as claimed claim 21, wherein the at least one cable is branched in a Y-shape having two cable ends which are connected to the pull via vehicle body mounted deflection rollers, the deflection rollers being located in the vicinity of two corners of the shade when it is completely drawn out.

24. Shade arrangement as claimed claim 21, wherein the at least one cable is anchored on the vehicle body at an end facing away from the cable drum on a fastening point which is located in the vicinity of a corner of the completely drawn out shade on a side of the shade opposite the cable drum, wherein the pull has a deflection roller one each of end areas thereof, and wherein the at least one cable is movably guided from the cable drum to the vehicle body mounted fastening point via the deflection rollers on the pull and a body-mounted deflection roller which is located in the vicinity of a fully drawn out corner of the shade that is on the same side of the shade as the cable drum.

25. Shade arrangement as claimed in claim 15, wherein the pull has sliders by means of which it is guided in body-mounted guides.

26. Motor vehicle body with a window and a shade arrangement, the shade arrangement comprising:
a take-up tube which is supported on a take-up shaft;
a pull;
a shade having a length of shade material, a first end of which is attached to the take-up tube and an opposite second end of which is connected to the pull;
a motor for turning the take-up shaft; and
at least one flexible driving element which is nonpositively connected to the take-up shaft and the pull;
wherein rotation of the take-up shaft by the driving element in an unwinding direction of the length of shade material produces a force on the pull that moves the shade material, the motor being a tube motor which is located within the take-up tube.

27. Motor vehicle body with an openable roof opening, an at least partially transparent or translucent cover with which the opening is closable and a shade arrangement for reducing the visibility through the roof opening, the shade arrangement comprising:
a take-up tube which is supported on a take-up shaft;
a pull;
a shade having a length of shade material, a first end of which is attached to the take-up tube and an opposite second end of which is connected to the pull;
a motor for turning the take-up shaft; and
at least one flexible driving element which is nonpositively connected to the take-up shaft and the pull;
wherein rotation of the take-up shaft by the driving element in an unwinding direction of the length of shade material produces a force on the pull that moves the shade material, the motor being a tube motor which is located within the take-up tube.

28. Roof module for a motor vehicle with an openable roof opening, an at least partially transparent or translucent cover with which the opening is closable and a shade arrangement for reducing the visibility through the roof opening, the shade arrangement comprising:
a take-up tube which is supported on a take-up shaft;
a pull;
a shade having a length of shade material, a first end of which is attached to the take-up tube and an opposite second end of which is connected to the pull;
a motor for turning the take-up shaft; and
at least one flexible driving element which is nonpositively connected to the take-up shaft and the pull;
wherein rotation of the take-up shaft by the driving element in an unwinding direction of the length of shade material produces a force on the pull that moves the shade material, the motor being a tube motor which is located within the take-up tube.
